(19) United States
(12) Patent Application Publication
(10) Pub. No.: US 2026/0174233 A1
(43) Pub. Date: Jun. 25, 2026

(54) CONTINUOUS COMPOSITE BODY MANUFACTURING

(71) Applicant: Altec Industries, Inc., Birmingham, AL (US)

(72) Inventors: Jeffrey Blettner, Indianola, IA (US); Ryan Hartford, Indianola, IA (US); Hunter Zwart, Thayer, IA (US); Maria Evers, Osceola, IA (US)

(21) Appl. No.: 18/988,196

(22) Filed: Dec. 19, 2024

(51) Int. Cl. A47B 96/20; B60R 9/02; B60R 11/06

(52) U.S. Cl. CPC A47B 96/202; A47B 96/205; B60R 9/02; B60R 11/06

(57) ABSTRACT

A composite body assembly and processes for creating the composite body assembly are described in embodiments of the disclosure. In some embodiments, the composite body assembly comprises an exterior frame comprising a continuous panel. The continuous panel may comprise a first skin, a second skin, and an inner core disposed between the first skin and the second skin. Furthermore, the continuous panel may be formed by a continuous manufacturing process comprising rolling the first skin and the second skin sandwiching the inner core. A double press controls the temperature and pressure forming the continuous panel. The continuous panel can then be cut and formed into an exterior frame of the composite body. Once the exterior frame is formed, partitions are provided, and doors are attached. Methods of hot plate welding provide a composite body that is entirely watertight with many components welded together to provide single-piece bodies.

### BACKGROUND

### 1. FIELD

Embodiments of the current disclosure relate to composite body manufacturing. More specifically, embodiments of the current disclosure relate to continuous panel construction and manufacturing of watertight composite bodies.

### 2. RELATED ART

Typical composite vehicle body structures are created by various methods including spraying gelcoat, spraying or laying fiberglass, and installing foams into molds. The (parts) may then be cured and assembled to form composite bodies. There are several drawbacks to traditional methods. For example, molds are static. Therefore, a different mold needs to be created for each different geometry. Furthermore, new molds must be created each time a part is modified. This can be very time consuming and expensive for parts with different geometries and different requests from customers.

Typical methods of creating composite sidewalls of large composite structures include discontinuous panels that are glued together. After the panels have been manufactured the panels are glued together then placed in a press and clamped for curing. The time for curing could be anywhere from hours to days depending on the materials and the adhesives used. Furthermore, in some methods, large ovens need to be used to complete or quicken the curing process. Curing takes time and warehouse space increasing the overhead of any composite manufacturing company utilizing standard methods.

Furthermore, when foam cores are used in the manufacturing of composite bodies, typical foam cores are limited to 8 ft long foam panels that must be glued to the skin next to each other creating potential weak points. Furthermore, the break points provide reduced thermal barrier points where heat can pass. Furthermore, these panels are also static as described above and must be cut to size for various composite part geometries.

What is needed are systems and methods of creating continuous composite panels that can be quickly formed into composite structures with low labor intensiveness and are environmentally friendly. Furthermore, these composite structures should be single piece structures to provide watertight barriers. Furthermore, the composite structures should be easily and quickly modified without the need for molds, reducing waste and quickening turnaround time.

### SUMMARY

Embodiments of the current disclosure solve the above-described problems and provide a distinct advance in the art by providing fully watertight composite bodies created by methods continuous panel manufacturing and hot plate welding components of the composite bodies.

An embodiment of the current disclosure comprises a composite body assembly. The composite body assembly comprises an exterior frame comprising a continuous panel, the continuous panel comprising one or more outer skins, an inner core coupled to the one or more outer skins, wherein at least the inner core is cut, and at least one outer skin of the one or more outer skins is bent adjacent to the cut to form at least one corner of the exterior frame, and a door frame coupled to the exterior frame.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIGS. 1A-1B depict an embodiment of a sidepack;

FIG. 2A depicts an embodiment of a continuous panel;

FIG. 2B depicts an embodiment of a system for creating the continuous panel;

FIG. 2C depicts a cross section of the continuous panel;

FIGS. 2D-2F depict a process of cutting and forming corners of an exterior frame;

FIG. 3A depicts an embodiment of a door frame;

FIGS. 3B-3C depict an embodiment of providing gutters to the sidepack;

FIG. 4 depicts an embodiment of a door;

FIG. 5 depicts a flow chart illustrating an exemplary process of forming the continuous panel; and

FIG. 6 depicts a flow chart illustrating an exemplary process of assembling the sidepack.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following description of embodiments of the invention references the accompanying illustrations that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the current technology can include a variety of combinations and/or integrations of the embodiments described herein.

Generally, embodiments of the current disclosure provide systems and methods for manufacturing composite bodies. The composite bodies described herein relate to assembling sidepacks for trucks; however, the sidepacks are exemplary and the systems and methods described herein can be used to create any type of composite bodies. for example, the continuous panel construction can be used for sidepacks, vehicle panels such as truck beds, car side panels, and the like. Furthermore, the systems and methods herein may be used to create camper and mobile home walls, floors, ceilings, and the like. In some embodiments, the composite structures described herein relate to building walls and floors and can be used in the aerospace industry as floors, interior walls and the like.

In some embodiments, as described in detail below, a continuous panel may be manufactured for composite bodies (e.g. the sidepack). The continuous panel comprising a first outer skin, a second outer skin, and an inner core may be continuously rolled out by a double belt press. The continuous panel may comprise various combinations of thermoplastic, thermosets, foam, and reinforcement material. Furthermore, once rolled and cooled, the continuous panel may be cut and formed to create continuous sidewalls and frames. Furthermore, because the inner core is created in the manufacturing process, no individual preformed inner core panels are used, so there are no weak points or reduced thermal barriers in the continuous panel.

In some embodiments, doors may be thermoformed from two outer door panels extruded and comprising thermoplastic. The door outer panels may sandwich an inner core comprising thermoset foam with a reinforcing material. Furthermore, the door outer panels may be hot plate welded or twin sheet thermoformed together.

A door frame may be formed and coupled to exterior frame face and configured to couple doors to the sidepack. In some embodiments, door frame may comprise a perimeter frame comprising sections of thermoset, metal, and/or thermoplastic that may be welded/connected together. In some embodiments, door frame may comprise any single homogenous component comprising any material (e.g., fiberglass, metal, carbon fiber, etc.) and may be cut or molded to shape. Furthermore, dividers may be welded to the perimeter sections in locations such that the dividers cover partitions in the cabinet spaced inside the exterior frame.

In some embodiments, partitions are placed inside exterior frame to create cabinets in the sidepack. The partitions may be panels, extruded thermoplastic, and/or thermoset and may be attached by, for example, welding, fastening, or bonding to an inner surface of exterior frame. In some embodiment, door frame may be bonded to exterior frame then partitions may be added. In some embodiments, the perimeter section of door frame is hot plate welded to exterior frame face and the dividers are welded to the partitions. As such, door frame matches the geometry of the cabinets in the sidepack.

Channels may be added to a top of the sidepack. The channels may be extruded thermoplastic and may be hot plate welded to a top of the exterior frame and/or a top of the door frame. The channels may be provided adjacent a front and/or a back of the sidepack to channel water over the sides of the sidepack. Furthermore, gutters may be added to the door frames. The gutters may also be extruded thermoplastic and hot plate welded to the door frames.

In some embodiments, the cabinets may be prepared for doors by adding notches, hinges, and seals. Here, notches may be formed in the door frame by melting and cutting the door frame to receive the hinges. The notches may be created such that no holes penetrate all the way through door frame and no fasteners are needed. As such, there are no holes allowing water to seep through. Therefore, sidepack remains completely watertight.

Once the notches have been added, the hinges may be snapped into the notches and the hinges may be snapped into notches provided on the doors. Furthermore, any seals and handles may be added to finish the sidepack. When finished, the components of the sidepack do not have holes and the sidepack may be entirely watertight. However, in some embodiments, bolt holes may be drilled through door frame for hinges.

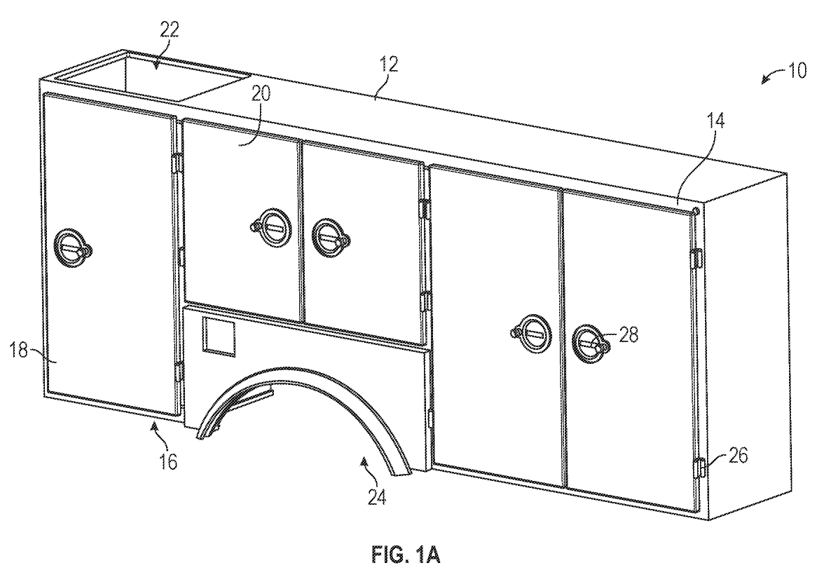

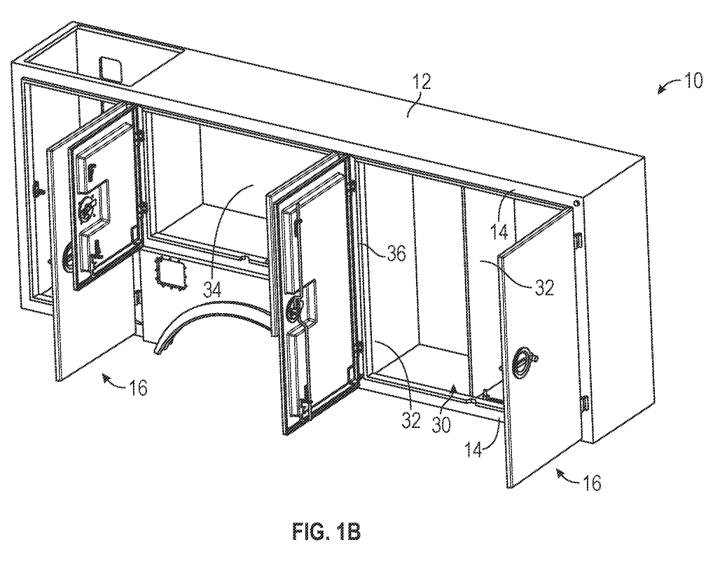

FIGS. 1A-1B depict sidepack 10. Here, sidepack 10 is used as an exemplary composite body; however, it should be understood that any components of sidepack 10 described herein could be used in manufacturing of any composite body with similar components. In some embodiments sidepack comprises exterior frame 12, door frame 14, doors 16, interior compartments 30 formed by partitions 32, and rear wall 34. In some embodiments, exterior frame 12 may comprise various openings to specific compartments as depicted by opening 22. Furthermore, doors 16 may be configured to enclose compartments 30 of various sizes (e.g., first door configuration 18 and second door configuration 20). Various configurations of doors 16 may be created. Furthermore, sidepack 10 may comprise wheel well 24, hinges 26, handles 28, seals 36, and various other components described in embodiments below.

As shown in FIG. 1B, cabinet partitions 32 are provided inside of sidepack 10 to create various interior compartments 30. In some embodiments, the partitions 32 may be extruded panels and may comprise thermoplastic, thermosets, metal, or any other material. For example, partitions 32 may be extruded thermoset panels and may be welded into place using hot-plate welding or any other method as described below. Welding partitions 32 eliminates holes in sidepack 10 preventing moisture, or any other substance, from transferring between compartments of sidepack 10. Once door frame 14 is added to sidepack 10, partitions can be added as described in detail below.

In some embodiments, sidepack 10 may be manufactured and configured to be mounted to the sides or the frame of a truck/truck bed. Any standard method of mounting sidepack 10 to a truck may be implemented. The arrangement of sidepack 10 in FIGS. 1A-1B are exemplary and other arrangements may be considered. Furthermore, as described above, the systems and methods of manufacturing the components described herein may apply to any composite body.

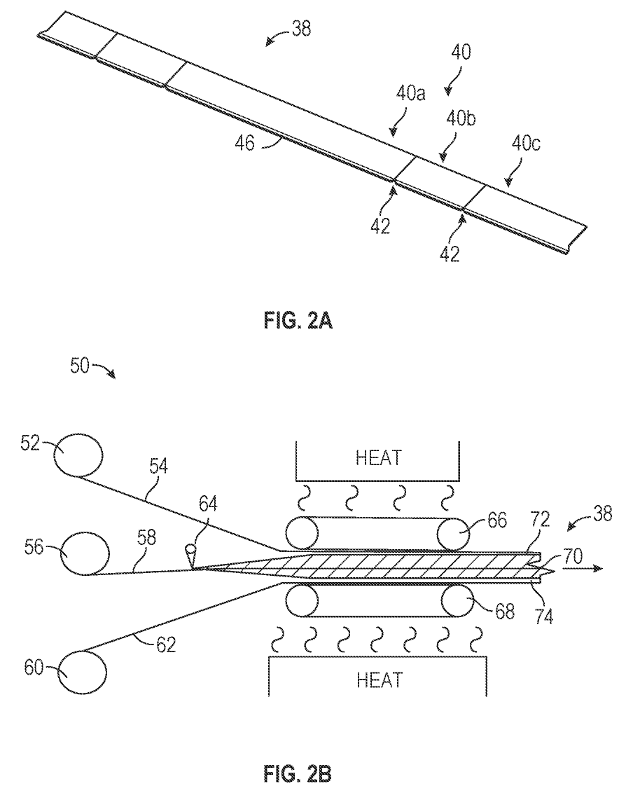

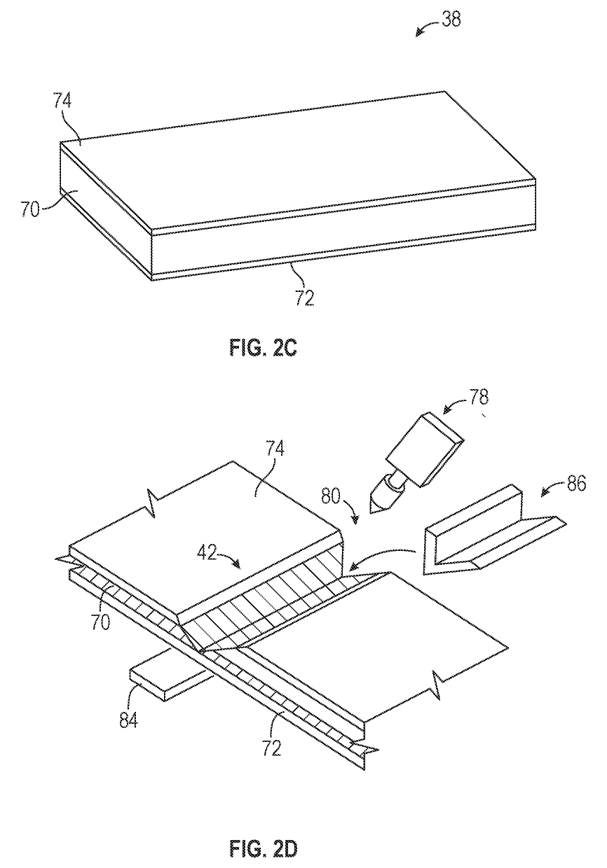

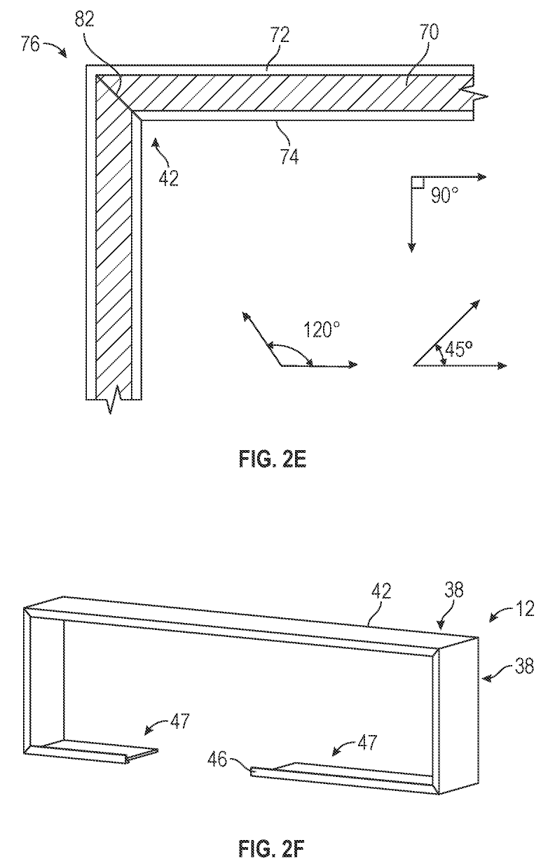

Turning now to FIGS. 2A-2F, in some embodiments, exterior frame 12 comprises and is formed from continuous panel 38 illustrated in FIG. 2A. Continuous panel 38 comprises various sections 40. For example, each section 40a, 40b, 40c, may be folded to eventually form sides, a top, a bottom and any other portions of exterior frame 12. In some embodiments, continuous panel 38 may be folded, or bent, at each cut 42 forming each corner of exterior frame 12. As described in detail below, corners 76 may be formed by cutting portions of continuous panel 38 and folding.

In some embodiments, continuous panel 38 may comprise outer skins (first outer skin 72 and second outer skin 74) and inner core 70 as depicted in FIGS. 2B-2E and formed by the system and process shown in FIG. 2B and described in detail below. Furthermore, continuous panel 38 may comprise frame face 46 also formed by cuts 42 and folding. Frame face 46 of exterior frame 12 may provide a structural rigidity and a location for door frame 14 to be secured. In some embodiments, door frame 14 may be coupled to frame face 46 as described in detail below.

FIGS. 2A-2F depicts systems and methods manufacturing continuous panel 38 and forming exterior frame 12. FIG. 2A depicts continuous panel 38 comprising panel sections 40 and cuts 42, which will become corners 76 of exterior frame 12. Continuous panel 38 may be formed in a continuous process described below and shown in FIG. 2B. Continuous panel 38, in some embodiments, comprises a sandwich configuration with outer layers (first outer skin 72 and second outer skin 74) comprising thermoplastic and/or thermoset and inner core 70 comprising foam and reinforcement materials such as, for example, fiberglass. As continuous panel 38 is continually formed, continuous panel 38 can be any length and width and, in some embodiments, any thickness. Continuous panel 38 may then be cut to dimensions to fit various sizes and shapes of various sidepacks or any other composite bodies as described above.

FIG. 2B depicts an exemplary manufacturing process 50 for creating continuous panel 38. As shown, continuous panel 38 may be manufactured in a double belt press comprising first belt press 66 and second belt press 68. First belt press 66 and second belt press 68 may be heated, or cooled, to control the temperature and pressure during the process. Controlling the environment using temperature-controlled belt presses provides the manufacturer accurate control over the final product. Therefore, the final product can be specifically controlled to provide a width, length, and thickness as well as strength and durability as specified by a customer. The controlled variability in manufacturing parameters provides real-time adjustments from one continuous panel creation to the next, which may be for different customers requesting different material and different dimensions.

As illustrated in FIG. 2B, first coil 52 provides first outer skin material 54 for a first outer skin 72 of continuous panel 38. First outer skin material 54 may be any material such plastic, fiberglass, carbon fiber, or the like. Here, first outer skin material 54 comprises thermoplastic. First outer skin material 54 may be provided in a roll and uncoiled by belt press rotating and pulling first outer skin material 54 into the belt press. As first outer skin material 54 is pulled into first belt press 66, first outer skin material 54 may be heated near a melting point of first outer skin material 54. Furthermore, first belt press 66 may press first outer skin material 54 into inner core material 64 as first outer skin material 54, inner core material 64 and second outer skin material 62 are heated. As described in more detail below, as the materials are heated and pressed the materials combine to form continuous panel 38.

In some embodiments, second outer skin material 62 may comprise thermoplastic, thermoset, fiberglass, carbon fiber, or any other material that may provide the characteristics described herein. For example, second outer skin material 62 may comprise a thermoset. The thermoset may provide a rigid and durable surface that complements inner core 70 and first outer skin 72 disposed on the opposite side of inner core 70. Furthermore, thermoset may provide high resistance to various chemicals such as, for example, oil, paint, gas, liquid adhesives, and the like, as these chemicals may regularly be stored in sidepack 10.

Second outer skin 74 may be formed by rolling out second outer skin material 62, which, in some embodiments, comprises the thermoset. Second outer skin material 62 may be rolled from third coil 60 using second belt press 68 as shown in FIG. 2B. Second belt press 68 may rotate as a conveyor similarly to first belt press 66 described above. Again, second belt press 68 may comprise a heating/cooling element controlling the temperature while the belt press controls the pressure applied to form continuous panel 38. As such, the environment in which continuous panel 38 is formed can be constantly controlled limiting variability in the final product. Furthermore, second outer skin 74 may comprise various reinforcement materials such as fiberglass or carbon fiber.

In some embodiments, first outer skin 72 and second outer skin 74 are provided as preconsolidated skin. The preconsolidated skin may be added to inner core 70 as inner core is formed in the process described below. Preconsolidated skin may be any material described herein related to first outer skin 72 and second outer skin 74. Preconsolidated skin may be heated and added to inner core 70 such that inner core and preconsolidated skin bond together. In some embodiments, outer skins 72, 74 may comprise thermoplastics including, for example, polycarbonate/polybutylene terephthalate (PC/PBT)). Furthermore, in some embodiments, inner core material 64 is provided on second outer skin material 62 or second outer skin 74 and no first outer skin 74 is provided.

In some embodiments, inner core 70 may be formed by rolling out a core reinforcement material 58 from second coil 56 and combine the core reinforcement material 58 with inner core material 64. Core reinforcement material 58 may be any material used for reinforcement of inner core material 64. In some embodiments, core reinforcement material 58 may be fiberglass and inner core material 64 may be a thermoset foam such as, for example, a wet-poured multi-component polyurethane foam. However, reinforcement material may also comprise carbon fiber and the like.

Furthermore, core material 64 may be added as a liquid foam or a semisolid intermediate foam state that provides a matrix for reinforcement material and provides a bonding agent to form continuous panel 38. Core material 64 and core reinforcement material 58 may be combined and provided on second outer skin material 62 and between first outer skin material 54 and second outer skin material 62 to create the sandwich configuration depicted in FIG. 2C. As first belt press 66 and second belt press 68 control the temperature and pressure applied to the combination of materials continuous panel 38 is formed. First outer skin material 54 and second outer skin material 62 may be pressed into core material 64 as reinforced core material solidifies and, in the process, adheres first outer skin material 54 to the reinforced core material and second outer skin material 62 to the reinforced core material creating continuous panel 38.

Once formed, inner core 70 provides versatility with better structural integrity, thermal integrity, and creep integrity over standard cores. Furthermore, as core material 64 is provided during formation of continuous panel 38, and in some embodiments is not a preformed panel, the chemical makeup of inner core material 64 can be modified quickly and simply. Therefore, the structural, thermal, and chemical properties of inner core 70, and therefore, continuous panel 38 can be easily and quickly changed to meet changing customer requests.

In some embodiments, inner core material 64 may be thermoset, which provides low cost and high thermal resistance and resistance to chemicals as described above. However, in some embodiments, inner core material 64 may comprise high-end thermoplastics (e.g., polyethylene terephthalate or polypropylene honeycomb), which may provide the same or similar benefit at higher costs.

FIG. 2C depicts an embodiment of continuous panel 38 showing each layer created by the process shown in FIG. 2B. Continuous panel 38, in some embodiments, comprises first outer skin 72 and second outer skin 74 sandwiching inner core 70. Here, first outer skin 72 comprises a thermoplastic layer, second outer skin 74 comprises a fiberglass reinforced thermoset layer, and inner core 70 comprises a thermoset foam reinforced with fiberglass. These materials are exemplary, and alternatives are listed above. As shown in FIGS. 2D-2F, continuous panel 38 is further processed to create exterior frame 12.

FIG. 2D depicts an exemplary embodiment cutting through second outer skin 74 and inner core 70 to allow for bending of first outer skin 72 to create corner 76 (FIG. 2E. In some embodiments, any cutting tool may be used. Here, cutting tool 78 (e.g., a router) is used with a cutting head to cut groove 80 comprising a desired angle into continuous panel 38. As shown, groove 80 is a v-shaped 90-degree angle allowing continuous panel 38 to be bent into corner 76 comprising a 90-degree angle. The cutting head may cut transversely on continuous panel 38 to create groove 80 as shown. The cut may be provided in second outer skin 74 and inner core 70. Accordingly, only first outer skin 72 remains adjacent groove 80.

As described above, first outer skin 72 may comprise thermoplastic. Therefore, the thermoplastic may be heated until the thermoplastic can be formed without losing integrity upon cooling. The thermoplastic may be heated and bent such that the two sides of groove 80 come together forming, in this example, the 90-degree corner 76 depicted in FIG. 2E. An adhesive may be added to groove 80 to seal the two sides of groove 80 to form the 90-degree corner 76. Adhesive may also be added as a fillet reattaching second outer skin 74. However, in some embodiments, hot plate welding may be used.

In some embodiments, hot plate welding may be used to bond and seal joint 82. For example, materials (e.g., thermoplastic or other materials) may be added at joint 82 between the two sides of groove 80. Hot plate welding may be used to heat each side using a miter that fits into groove 80. For example, if groove presents a 90-degree angle, a simple 90-degree positive miter 86 may be placed into groove 80 heating each side. Furthermore, simultaneously, a heated hot plate 84 may be provided to the outside of first outer skin 72 to heat for bending. Once first outer skin 72 is heated to the point of bending without degradation of the material structure and the two faces of groove 80 with thermoplastic added material is heated to bonding, first outer skin 72 may be bent to contact the two faces of groove 80. When the added thermoplastic has cooled, joint 82 is complete. The hot plate welding method described herein may be used on various parts described below.

As shown in FIG. 2E any angle may be created for corner 76. As shown in FIG. 2D groove comprises a 90-degree angle; however, the 90-degree angle is exemplary, and other angles may be created. For example, groove 80 may be cut using cutting tool 78 to an angle less than 90-degrees creating an obtuse angle for corner 76 (e.g., 120-degree angle), and groove 80 may be cut to more than a 90-degree angle creating an acute corner (e.g., 45-degree angle). Any angle of corner 76 may be created by implementing the above-described process.

Furthermore, frame face 46 of exterior frame 12 may be created by cutting groove 80 and bending first outer skin 72 as described in the process above. Frame face 46 may be any width and span the length of any side of exterior frame 12. Frame face 46, in some embodiments, provides structure to exterior frame 12 as well as providing a surface to which door frame 14 may be coupled.

FIG. 2F depicts an exemplary geometry of exterior frame 12 used for sidepack 10. Because of the cutting, bending, and bonding manufacturing techniques described above there is no need for molds. Therefore, the geometry is dynamic. The geometry of exterior frame 12 and other parts described below may be any length, width, thickness, and cuts and bends can be made at any point along the lengths and widths. Therefore, continuous panel 38 may be manipulated to form any geometry of exterior frame 12 imaginable without the need to produce new molds. These techniques provide real-time adaptive methods of creating composite bodies without production of any intermediate components (e.g., molds and tooling). Furthermore, using the techniques described herein, there is limited need for curing, which takes up time and space in typical processes. Here, the belt press is heated to control the chemical and thermal reaction times in a stable environment. As such, there is limited need for curing the materials and bonds.

It should also be noted that exterior frame 12 may comprise components in addition to continuous panel 38. For example, the top and two sides as shown in FIG. 2F may be the continuous panel 38 while the bottom portions 47 may be separate panels that are coupled to continuous panel 38. Any portions of exterior frame 12 may comprise continuous panel 38 while other portions may be separate panels coupled to continuous panel 38. Furthermore, the manufacturing process described herein can be considered separate from the continuous panel 38. In some embodiments, continuous panel 38 may be any panel that is not formed from multiple adjoining panels but can include a single panel comprising a single layer or multiple layers comprising various materials (e.g., thermoplastic, thermoset, and the like) described herein.

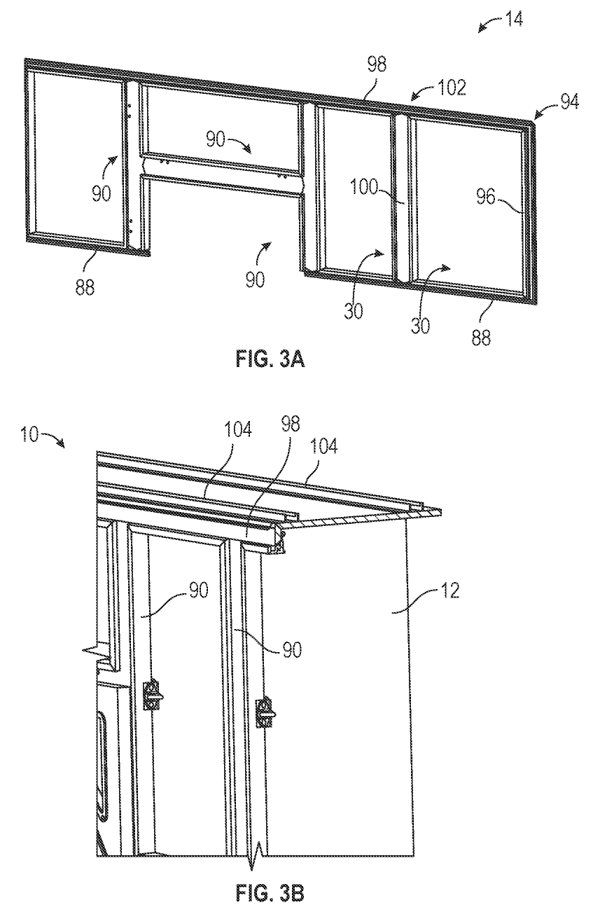

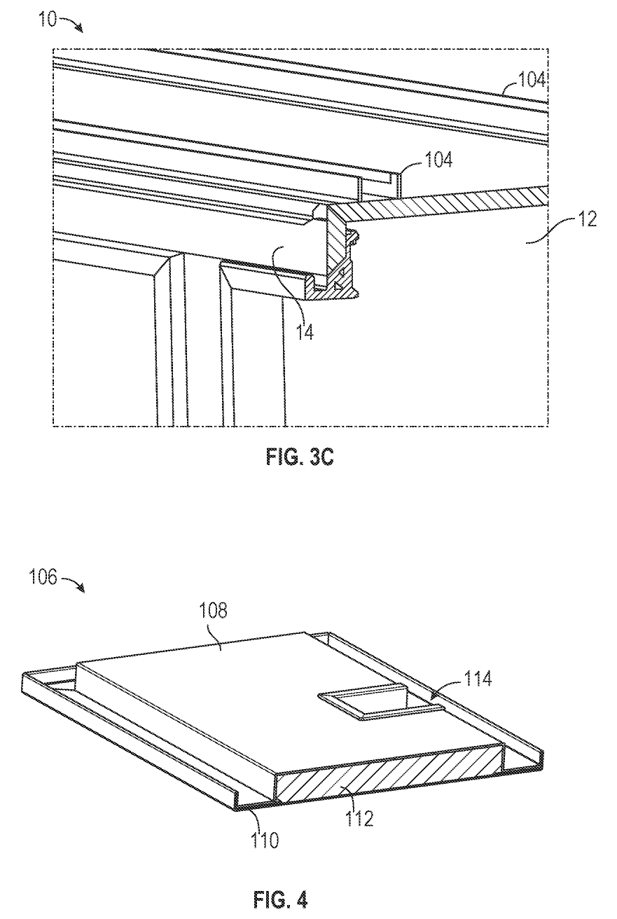

FIG. 3A depicts an embodiment of door frame 14. Door frame 14, in some embodiments, comprises a thermoplastic extruded into shape and hot plate welded to create the configuration of door frame 14 matching the face of sidepack 10. In some embodiments, door frame may comprise any single homogenous component comprising any material (e.g., fiberglass, metal, carbon fiber, etc.) and may be cut or molded to shape. In some embodiments, perimeter pieces 88, 98 and dividers 90 comprise one or more door frame pieces assembled to create door frame 14. Each piece of door frame 14 may be independently extruded or extruded in a continuous door frame panel and cut to form each piece as described in relation to continuous panel 38 above. Once each door frame piece is created, the door frame pieces may be assembled and welded to create door frame 14 in any configuration to match the compartments 30 of sidepack 10.

In some embodiments, each door frame piece may comprise extruded thermoplastic and may be formed and/or cut to provide a welding surface to be coupled to frame face 46 of exterior frame 12. Furthermore, each door frame piece may comprise various features configured for coupling doors 16 and channel 104 as described below. Features may include flat surfaces and protrusions providing a size and shape for receiving and coupling to doors 16, channel 104, and receiving hinges 26, and any other components described below.

In some embodiments, dividers 90 including vertical divider 100 may be coupled (e.g., bonded, bolted, or welded) to perimeter piece 88, 96, 98 to create door frame 14 fully sealed from moisture. Here, a compound miter may be applied to the 90-degree joint 102 between, for example, vertical divider 100 and perimeter top piece 98. In this example, perimeter top piece 98 comprises a negative miter and vertical divider 100 comprises the positive miter; however, in some embodiments, the shape may be provided, and the miter may be opposite. Here, a hot plate comprising the shapes of the positive and negative miters may be applied to heat and weld vertical divider 100 to perimeter top piece 98 utilizing the hot plate methods described above. Heat may be applied to both the perimeter top piece 98 and dividers 90 as the perimeter top piece 98 and the dividers 90 are pressed together after heated until cooled.

Furthermore, in some embodiments, door frame 14 comprises perimeter top piece 98, perimeter bottom piece 88, perimeter side piece 96, and dividers 90 including vertical divider 100. Perimeter top piece 98 and perimeter bottom piece 88, in some embodiments, are coupled to frame face 46 by adhesives and/or by hot plate welding methods described above. Each door frame corner 94 of door frame 14 may be welded utilizing hot-plate welding. For example, perimeter side piece 96, which in some embodiments is a divider 90, may be cut with a 45-degree angle complimentary to a 45-degree angle cut in perimeter top piece 98 and perimeter bottom piece 88. For example, perimeter top piece 98 may be placed against perimeter side piece 96 such that the two complimentary angles provide adjoining surfaces. In some embodiments, 45-degree miters or flat hot plates may be used to apply non-stick coated (e.g., polytetraflouroethylene) hot plates surfaces to heat the perimeter top piece 98 45-degree surface and perimeter side piece 96 45-degree surface at corner 94. As perimeter side piece 96 and perimeter top piece 98 are heated the 45-degree surfaces begin to melt providing a location (i.e., corner 94) where the two panels can be joined. The two surfaces may then be pressed together and cooled to create a welded bond creating corner 94. Furthermore, once cooled, the thermoplastic of door frame 14 solidifies providing a watertight sealed corner. Each corner may be sealed using this method providing door frame 14 fully sealed from moisture.

Once cooled, perimeter pieces 88, 98, perimeter side pieces 96, and dividers 90 are coupled together providing a fully coupled joint that is sealed to prevent any moisture from crossing the joint into sidepack 10. When all dividers 90 have been coupled to perimeter pieces 88, 98, and perimeter side pieces 96, door frame 14 is created as an entire single component with coupled joints (e.g., bonded, bolted, or welded). Door frame 14 comprising a single component provides various benefits such as, for example, a seamless complex geometry with high run and low labor.

FIGS. 3B-3C depict channels 104. In some embodiments, channels 104 comprise a channel geometry configured for channeling water way from sidepack while providing a mounting surface for top mounted components. In some embodiments channels 104 are extruded providing a U-shaped geometry as shown in FIGS. 3B and 3C. 10. Channels 104 may comprise thermoplastic that may be welded to exterior frame 12 near the front and back of sidepack 10. As described above, in some embodiments, channels 104 may be hot plate welded to the top of exterior frame 12 or to a frame top of door frame 14. Hot plate welding or bonding prevents any fastener holes that may allow moisture to seep into sidepack 10. In some embodiments, channels 104 may be configured to receive bolts and screw and may be configured to couple to the other components using adhesive or hot plate welding.

FIG. 4 depicts an exemplary door 106 of doors 16 (FIGS. 1A-1B). Door 106 in some embodiments, comprises extruded thermoplastic panels (e.g., first door panel 108 and second door panel 110) that are plastic welded together with a door inner core 112. In some embodiments, door inner core 112 comprises a foam thermoset as described above; however, door inner core 112 may comprise other materials such as, for example, thermoplastics. In some embodiments, door inner core 112 may comprise reinforcing material such as fiberglass as described in relation to inner core 70 above. As such, door 106 may be a twin sheeted (e.g., first door panel 108 and second door panel 110) thermoformed foam filled door. In some embodiments, first door panel 108 and second door panel 110 are heated and compressed thermally welding the panels together with door inner core 112 sandwiched between or post filled by injecting a core. Furthermore, in some embodiments, handle section 114 may be a recessed section with notches configured to receive and secure the inner section of a door handle mechanism configured to open door 106.

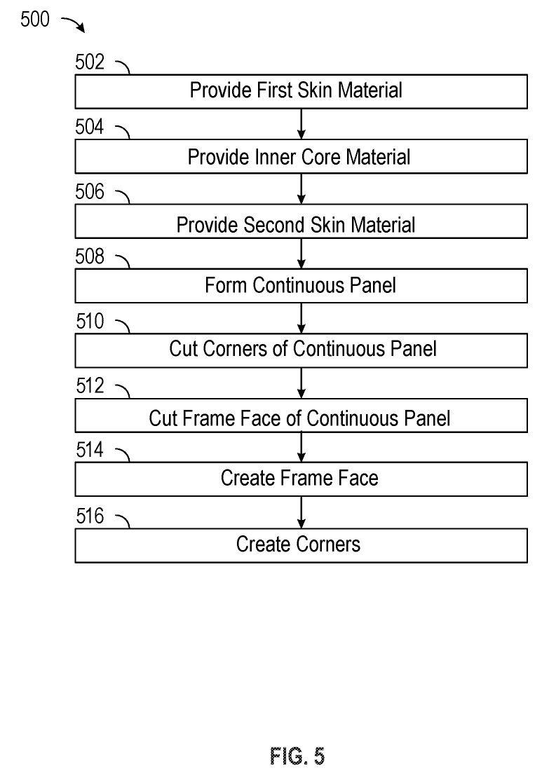

FIG. 5 depicts an exemplary process of forming continuous panel 38 generally referenced by numeral 500. At step 502, second outer skin material 62 is provided to the double belt press. In some embodiments, second outer skin material 62 comprises thermoplastic and may be used as the bending surface for exterior frame 12. Second outer skin material 62 may be provided by third coil 60 as described above. Second outer skin material 62 may be pulled by first belt 66 or second belt 68, which may be heated or cooled to control the temperature and pressure applied to continuous panel 38. Inner core material 64 may be applied on top of second outer skin material 62. Here, inner core material 64 may be wet providing a sticking surface to bond second outer skin material 62 to inner core material 64 without the use of additional adhesives.

At step 504, inner core material 64 may be provided on second outer skin material 62 and/or between first outer skin material 54 and second outer skin material 62. In some embodiments, inner core material 64 may comprise a foam. The foam may be heated to provide a liquid or semisolid such that first outer skin material 54 and second outer skin material 62 stick to the foam when compressed between first belt press 66 and second belt press 68. In some embodiments, foam may comprise thermoplastic reinforced with reinforcing material 58 such as, for example, fiberglass. This foam may also be provided as a multi-component liquid that reacts in the process to create a foam bonding the two skin materials together.

At step 506, first outer skin material 54 may be provided between inner core material 64 and first belt press 68 of double belt press. First outer skin material 54 may comprise a thermoset. As described in embodiments above, first outer skin material 54 may be rolled off of third coil 60 and by second belt 68 rotating and pulling first outer skin material 54 into contact with inner core materiel 64. Here, inner core material 64 may be wet providing a sticking surface such that additional adhesive to bond first outer skin material 54 is not required. In some embodiments, first outer skin material 54 may be optional and continuous panel 38 may comprise only second outer skin 74 and inner core 70.

At step 508, in some embodiments, the double belt press presses and heats continuous panel 38. As described above, the double belt press comprises first belt 66 and second belt 68 working together to form continuous panel 38. The temperature of first belt 66 and second belt 68 may be controlled by heaters to minimize any inconsistency in the bond between inner core 70, first outer skin 72, and second outer skin 74. Furthermore, as continuous panel 38 is rolled, continuous panel 38 is pressed to create a desired thickness and to create a bond between the layers. As continuous panel 38 is moved down the belt, continuous panel 38 may be cooled to form the bond between inner core 70, first outer skin 72, and second outer skin 74.

At step 510, after continuous panel 38 is formed, continuous panel 38 may be cut into sections, each section eventually forming a side, top, or bottom section of exterior frame 12. Any standard cutting tool may be used; however, groove 80 cut into the panels may be a specific angle depending on the corner to be formed. For example, if corner 76 of exterior frame 12 is 90 degrees the angle cut into continuous panel 38 may be 90 degrees or less to account for springback. If the corner 76 has an inner angle of 120 degrees, the angle cut into the panel will be 60 degrees. If the inner angle of the corner 76 is to be 45 degrees, the angle of groove should be 135 degrees, and so on. Furthermore, groove 80 may be cut through the inner panel (e.g., second outer skin 74) comprising thermoset and inner core 70. Therefore, the layer left forming continuous panel 38 is the thermoplastic layer (first outer skin 72 in the examples above). Thermoplastic layer may then be heated and bent with each of the sides of groove 80 contacting to form corner 76 as described in step 514 below.

At step 512, continuous panel 38 may be cut to form frame face 46. As described in step 510 above, continuous panel 38 may again be cut through the inner core 70 and the thermoset layer to expose only the thermoplastic layer. Here, continuous panel 38 may be cut near a long edge to create the frame face groove for forming frame face 46 as described in step 516 below.

At step 514, first outer skin 72 (thermoplastic layer) may be heated and bent to form frame face 46 as cut in step 512. First outer skin 72 may be heated to a deformation point using a heat source. Furthermore, the faces of the groove of frame face may be heated using hot plate welding as described above. After first outer skin 72 is bent to contact the faces the groove of frame face 46, first outer skin 72 may be cooled to conserve the bent shape.

At step 516, each corner 76 may be welded to provide exterior frame 12. In some embodiments, a welding material (e.g., thermoplastic) may be added to bond each side of corner 76 together to create corner 76. For example, a thermoplastic material may be added to each side of groove 80 and heated using a hot plate comprising a miter corresponding to the angle of groove 80. The first outer skin 72 is then bent to contact the two sides comprising the melted material to bond the sides of groove 80. When the material cools, corner 76 is created comprising a watertight bond. Once complete, exterior frame 12 including frame face 46 is complete and ready for assembly to create sidepack 10 as described in the processes below.

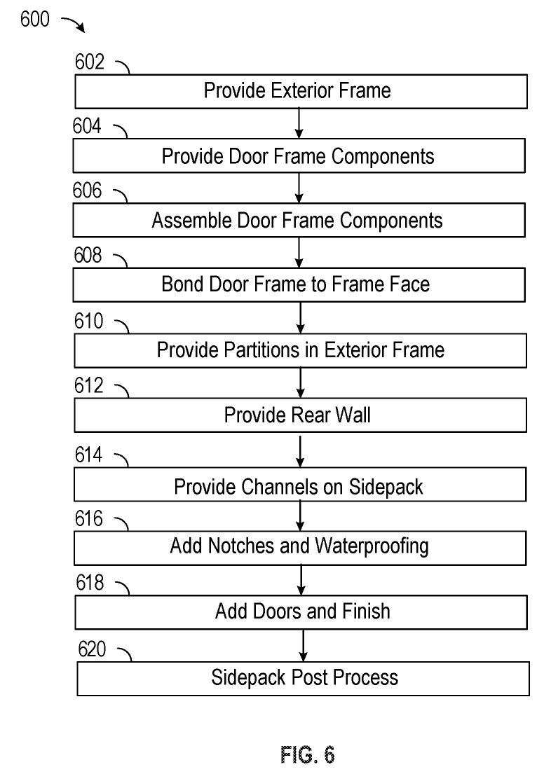

FIG. 6 depicts a process of assembling sidepack 10 generally referenced by the numeral 600. At step 602, exterior frame 12 is provided as described above. In some embodiments, exterior frame 12 comprises inner core 70 sandwiched between first outer skin 72 and second outer skin 74. Furthermore, exterior frame 12 comprises frame face 46 configured to receive door frame 14. In some embodiments, first outer skin 72 comprises thermoplastic, second outer skin 74 comprises thermoset, and inner core 70 comprises thermoset foam reinforced with fiberglass.

Steps 604-606 can be considered a process of created door frame 14. At step 604, door frame perimeter pieces 98, 96, 88 and door frame dividers 90 are provided. In some embodiments, door frame perimeter pieces 98,96, 88 and dividers 90 are extruded utilizing standard plastic extrusion techniques. Dividers 90 and door frame perimeter pieces 98, 88 may comprise thermoplastic or thermoset and may be extruded comprising various peaks and valleys for assembly as described in embodiments above.

At step 606, door frame perimeter sections (e.g., perimeter side pieces 96 and perimeter pieces 98, 88) and dividers 90 may be assembled to create door frame 14. Door frame perimeter sections and dividers 90 may be cut and hot plate welded to create door frame 14 by applying thermoplastics and utilizing heated miters and plates, or adhesives to adhere the components together. In the case that perimeter sections and dividers 90 are thermoplastic, hot plates may be applied to the joints to bond the perimeter sections and dividers 90 to create door frame 14 as described in embodiments above. Door frame 14, when complete, may be a single bonded component providing watertight bonds as described above.

At step 608, door frame 14 may be coupled to frame face 46. In some embodiments, door frame 14 may be coupled to frame face 46 by hot plate welding and/or adhesives. As described above, thermoplastics may be provided between any thermosets and/or thermoplastic/thermoset bonds. The thermoplastics may be heated using non-adhesive plates directly against the plastic faces to be joined. Here, plates may be used on the flush joints while miters may be used on angles. Furthermore, in some embodiments, door frame 14 and frame face 46 are both thermoplastics. As such, door frame 14 and frame face 46 may be welded directly without intermediate materials or adhesives. The door frame 14 may be bonded to frame face 46 leaving a fully watertight joint around the exterior frame 12.

At step 610, partitions 32 may be provided in exterior frame 12 to create compartments. Partitions 32 may be panels of thermoset and/or thermoplastic and/or metal and provided inside exterior frame 12 to create the various compartments 30. In some embodiments, partitions 32 may be welded to the interior side (e.g., thermoset layer) of exterior frame 12. The welding may be performed by hot plate welding. For example, materials (e.g., thermoplastic) may be added at the joints between partitions 32 and exterior frame 12, and hot miters configured to match the angles between partitions 32 and exterior frame 12 may be applied. The hot miters may melt the materials then, after cooling, a watertight bond is created between partitions 32 and exterior frame 12 creating the various compartments 30. In some embodiments, based on materials, no material is added, and the hot miters melt and weld partitions 32 to exterior frame 12 directly.

At step 612, rear wall 34 comprising a panel of thermoset, thermoplastic, or metal composition is attached to the composite body. In some embodiments, rear wall 34 may be attached to the back of exterior frame 12 and/or dividers 90 as shown in FIG. 1B. Rear wall 34 may be attached by adhesive, welding, hot plate welding, fasteners, and/or any other coupling method. Rear wall 34 may be formed by any method described herein or may be a preconstructed panel.

At step 614, channel 104 may be provided. As described above, channel 104 may be extruded thermoplastic and welded using the hot plate welding methods described herein. Channel 104 may be coupled to the top of exterior frame 12 and/or the frame top of door frame 14. A first channel 104 may be provided adjacent to the front of the sidepack 10 (e.g., on the top of door frame 14) and adjacent to the back of sidepack 10 as described above. Channel 104 may be configured to channel water away from the front and back of sidepack 10 and over the sides of sidepack 10. These channels may also be used for attaching top mounted components.

At step 616, any notches and cuts as well as additional waterproofing may be provided on sidepack 10 for fitting final components. For example, notches may be cut or hot-pressed to secure hinges 26 for doors 16. The notches may be cut into first outer skin 72, second outer skin 74, and inner core 70 to secure any components. Any holes may provide a location for moisture to penetrate into the compartments 30. As such, indentions and notches can be formed in the walls to snap components into place leaving the interior of sidepack 10 completely waterproof.

Once hinges 26 have been coupled to door frame 14, at step 618, doors 16 may be added to the hinges 26. Once doors 16 have been coupled to hinges 26 by bolts, for example, at step 620, any post processing may be performed. For example, any seals may be added to doors 16 and/or door frame 14 if the seals were not provided above. Any final finishing coatings and/or paints may be applied to sidepack 10. Furthermore, testing of the doors 16 and waterproofing may be performed.

In some aspects, the techniques described herein relate to a composite body assembly, including: an exterior frame including a continuous panel, the continuous panel including: one or more outer skins; an inner core coupled to the one or more outer skins, wherein at least the inner core is cut, and at least one outer skin of the one or more outer skins is bent adjacent to the cut to form at least one corner of the exterior frame; and a door frame coupled to the exterior frame.

In some aspects, the techniques described herein relate to a composite body assembly, wherein the one or more outer skins include thermoplastic and the inner core includes reinforced foam

In some aspects, the techniques described herein relate to a composite body assembly, wherein the one or more outer skins includes a first outer skin and a second outer skin, and wherein the first outer skin and the second outer skin are bonded to the inner core by the inner core when the inner core is formed.

In some aspects, the techniques described herein relate to a composite body assembly, further including a frame face coupled to the exterior frame, wherein the door frame includes a perimeter and one or more dividers; wherein the one or more dividers are coupled to the perimeter, and wherein the door frame is coupled to the frame face.

In some aspects, the techniques described herein relate to a composite body assembly, wherein the door frame and the frame face include thermoplastic and are directly welded, bonded, or mechanically attached together.

In some aspects, the techniques described herein relate to a composite body assembly, further including a channel disposed on a top of the exterior frame or a frame top of the door frame, wherein the channel is hot plate welded, bonded, or mechanically attached to the top of the exterior frame or the frame top of the door frame.

In some aspects, the techniques described herein relate to a composite body assembly, further including one or more doors, wherein each door of the one or more doors includes: a first door outer skin; a second door outer skin; and a door inner core.

In some aspects, the techniques described herein relate to a composite body assembly, wherein the first door outer skin and the second door outer skin include thermoplastic and are twin sheet thermoformed together.

In some aspects, the techniques described herein relate to a composite body assembly, including: an exterior frame including a continuous panel, the continuous panel including: one or more outer skins; an inner core coupled to the one or more outer skins, wherein at least the inner core is cut, and at least one outer skin of the one or more outer skins is bent adjacent to the cut to form at least one corner of the exterior frame; one or more partitions provided inside the exterior frame to create compartments; and a door frame coupled to the exterior frame.

In some aspects, the techniques described herein relate to a composite body assembly, wherein the one or more outer skins is bonded to the inner core by the inner core when the inner core is formed; and wherein the one or more outer skins include thermoplastic and the inner core includes reinforced thermoset foam.

In some aspects, the techniques described herein relate to a composite body assembly, wherein the door frame includes a perimeter frame and dividers, wherein the dividers are hot plate welded, bonded, welded, or mechanically attached to the perimeter frame, and wherein the door frame is hot plate welded, bonded, or mechanically attached to a frame face.

In some aspects, the techniques described herein relate to a composite body assembly, wherein the door frame and the frame face are directly welded, bonded, or mechanically attached together.

In some aspects, the techniques described herein relate to a composite body assembly, further including one or more doors; wherein the one or more doors includes: a first door outer skin including thermoplastic; a second door outer skin including thermoplastic; and a door inner core including thermoset.

In some aspects, the techniques described herein relate to a composite body assembly, wherein the composite body assembly forms a sidepack and is configured to be coupled to a vehicle.

In some aspects, the techniques described herein relate to a composite body assembly, including: an exterior frame including a continuous panel, the continuous panel including: one or more outer skins; an inner core coupled to the one or more outer skins, wherein at least the inner core is cut, and at least one outer skin of the one or more outer skins is bent adjacent to the cut to form at least one corner of the exterior frame; a frame face coupled to the exterior frame; and a door frame coupled to the frame face of the exterior frame.

In some aspects, the techniques described herein relate to a composite body assembly, wherein the one or more outer skins is bonded to the inner core by the inner core when the inner core is formed; and wherein the one or more outer skins include thermoplastic, thermoplastic, or metal and the inner core includes reinforced thermoset foam.

In some aspects, the techniques described herein relate to a composite body assembly, wherein the door frame includes a perimeter frame and dividers, wherein the dividers are hot plate welded, bonded, welded, or mechanically attached to the perimeter frame, and wherein the door frame is hot plate welded, bonded, or mechanically attached to the frame face.

In some aspects, the techniques described herein relate to a composite body assembly, wherein the inner core includes a fiberglass or carbon fiber reinforced thermoset.

In some aspects, the techniques described herein relate to a composite body assembly, further including one or more doors, wherein the one or more doors includes: a first door outer skin including thermoplastic; a second door outer skin including thermoplastic; and a door inner core including thermoset.

In some aspects, the techniques described herein relate to a composite body assembly, wherein the composite body assembly forms a sidepack and is configured to be coupled to a vehicle.

Although the invention has been described with reference to the embodiments illustrated in the attached drawing figures, it is noted that equivalents may be employed, and substitutions made herein without departing from the scope of the invention.

Having thus described various embodiments of the disclosure, what is claimed as new and desired to be protected by Letters Patent includes the following:

1. A composite body assembly, comprising:
an exterior frame comprising a continuous panel, the continuous panel comprising:
one or more outer skins;
an inner core coupled to the one or more outer skins,
wherein at least the inner core is cut, and at least one outer skin of the one or more outer skins is bent adjacent to the cut to form at least one corner of the exterior frame; and
a door frame coupled to the exterior frame.

2. The composite body assembly of claim 1, wherein the one or more outer skins comprise thermoplastic and the inner core comprises reinforced foam.

3. The composite body assembly of claim 2,
wherein the one or more outer skins comprises a first outer skin and a second outer skin, and
wherein the first outer skin and the second outer skin are bonded to the inner core by the inner core when the inner core is formed.

4. The composite body assembly of claim 1,
further comprising a frame face coupled to the exterior frame,
wherein the door frame comprises a perimeter and one or more dividers;
wherein the one or more dividers are coupled to the perimeter, and
wherein the door frame is coupled to the frame face.

5. The composite body assembly of claim 4,
wherein the door frame and the frame face comprise thermoplastic and are directly welded, bonded, or mechanically attached together.

6. The composite body assembly of claim 1,
further comprising a channel disposed on a top of the exterior frame or a frame top of the door frame,
wherein the channel is hot plate welded, bonded, or mechanically attached to the top of the exterior frame or the frame top of the door frame.

7. The composite body assembly of claim 1,
further comprising one or more doors,
wherein each door of the one or more doors comprises:
a first door outer skin;
a second door outer skin; and
a door inner core.

8. The composite body assembly of claim 7, wherein the first door outer skin and the second door outer skin comprise thermoplastic and are twin sheet thermoformed together.

9. A composite body assembly, comprising:
an exterior frame comprising a continuous panel, the continuous panel comprising:
one or more outer skins;
an inner core coupled to the one or more outer skins,
wherein at least the inner core is cut, and at least one outer skin of the one or more outer skins is bent adjacent to the cut to form at least one corner of the exterior frame;
one or more partitions provided inside the exterior frame to create compartments; and
a door frame coupled to the exterior frame.

10. The composite body assembly of claim 9,
wherein the one or more outer skins is bonded to the inner core by the inner core when the inner core is formed; and
wherein the one or more outer skins comprise thermoplastic and the inner core comprises reinforced thermoset foam.

11. The composite body assembly of claim 9,
wherein the door frame comprises a perimeter frame and dividers,
wherein the dividers are hot plate welded, bonded, welded, or mechanically attached to the perimeter frame, and
wherein the door frame is hot plate welded, bonded, or mechanically attached to a frame face.

12. The composite body assembly of claim 11, wherein the door frame and the frame face are directly welded, bonded, or mechanically attached together.

13. The composite body assembly of claim 9,
further comprising one or more doors;
wherein the one or more doors comprises:
a first door outer skin comprising thermoplastic;
a second door outer skin comprising thermoplastic; and
a door inner core comprising thermoset.

14. The composite body assembly of claim 13, wherein the composite body assembly forms a sidepack and is configured to be coupled to a vehicle.

15. A composite body assembly, comprising:
an exterior frame comprising a continuous panel, the continuous panel comprising:
one or more outer skins;
an inner core coupled to the one or more outer skins,
wherein at least the inner core is cut, and at least one outer skin of the one or more outer skins is bent adjacent to the cut to form at least one corner of the exterior frame;
a frame face coupled to the exterior frame; and
a door frame coupled to the frame face of the exterior frame.

16. The composite body assembly of claim 15,
wherein the one or more outer skins is bonded to the inner core by the inner core when the inner core is formed; and
wherein the one or more outer skins comprise thermoplastic, thermoplastic, or metal and the inner core comprises reinforced thermoset foam.

17. The composite body assembly of claim 15,
wherein the door frame comprises a perimeter frame and dividers,
wherein the dividers are hot plate welded, bonded, welded, or mechanically attached to the perimeter frame, and
wherein the door frame is hot plate welded, bonded, or mechanically attached to the frame face.

18. The composite body assembly of claim 17, wherein the inner core comprises a fiberglass or carbon fiber reinforced thermoset.

19. The composite body assembly of claim 15,
further comprising one or more doors,
wherein the one or more doors comprises:
a first door outer skin comprising thermoplastic;
a second door outer skin comprising thermoplastic; and
a door inner core comprising thermoset.

20. The composite body assembly of claim 15, wherein the composite body assembly forms a sidepack and is configured to be coupled to a vehicle.
